(19) United States
(12) Patent Application Publication
(10) Pub. No.: US 2014/0118350 A1
(43) Pub. Date: May 1, 2014

(54) Seismic Pattern Recognition Using Attributed Relational Graphs

(71) Applicants: Matthias Imhof, Katy, TX (US); Pavel Dimitrov, Houston, TX (US); Weicheng Shen, Vienna, VA (US)

(72) Inventors: Matthias Imhof, Katy, TX (US); Pavel Dimitrov, Houston, TX (US); Weicheng Shen, Vienna, VA (US)

(21) Appl. No.: 14/122,565

(22) PCT Filed: May 9, 2012
(86) PCT No.: PCT/US2012/037107

§ 371 Date: Nov. 26, 2013

Related U.S. Application Data
(60) Provisional application No. 61/509,916, filed on Jul. 20, 2011.

(51) Int. Cl. G06T 11/20; G06T 15/08

(52) U.S. Cl. CPC G06T 11/206; G06T 15/08
USPC 345/424

(57) ABSTRACT

Seismic pattern recognition using an attributed relational graph matching-based fingerprint classification and identification method for identifying features of possible hydrocarbons significance in a seismic data volume (10). The seismic data are reduced to line representations (11), which are represented in a graph structure (12), having edges and vertices. Various attributes such as polarity are associated (14) with the edges and vertices, thereby creating an attributed relational graph, which is then searched for matches (16) with a selected pattern (15) considered to have hydrocarbon significance (18).

### CROSS-REFERENCE TO RELATED APPLICATION

This application claims the benefit of U.S. Provisional Patent Application 61/509,916, filed Jul. 20, 2011, entitled SEISMIC PATTERN RECOGNITION USING ATTRIBUTED RELATIONAL GRAPHS, the entirety of which is incorporated by reference herein.

### FIELD OF THE INVENTION

This invention relates generally to the field of geophysical prospecting, and more particularly to the analysis of seismic data. Specifically, the invention is a method in the field of hydrocarbon exploration and production for the representation of seismic data and search for features therein that are analogous to specified ones.

### BACKGROUND OF THE INVENTION

Seismic data volumes are three-dimensional images of the subsurface that are computed from seismic recordings for the purpose of locating and characterizing hydrocarbon reservoirs. These images show both geophysical and geological features. Traditional analysis of these data is often tedious, labor intensive and time consuming Among things that are needed is a system that allows the interpreter to formulate a request or query for a particular geometric arrangement of subsurface layers as expressed in the seismic image.

Many statistical pattern analysis and classification methods have been developed to address various aspects of seismic interpretation or seismic stratigraphy with various degrees of success. Statistical pattern classification methods normally make decisions based on some numerical feature vectors. Examples of such statistical pattern matching methods for seismic data include:
U.S. Pat. No. 6,226,596 (“Method for Analyzing and Classifying Three Dimensional Seismic Information”) to Gao;
U.S. Pat. No. 6,438,493 (“Method For Seismic Facies Interpretation Using Textural Analysis And Neural Networks”) to West and May.
U.S. Pat. No. 6,560,540 (“Method For Mapping Seismic Attributes Using Neural Networks”) to West and May;
U.S. Pat. No. 6,957,146 (“System for utilizing seismic data to estimate subsurface lithology”) to Turhan and Carr;
U.S. Patent Application No. 20100017354 (“Interpreting A Plurality Of M-Dimensional Attribute Vectors Assigned To A Plurality Of Locations In An N-Dimensional Interpretation Space”) by Chan, Gesbert, Masters, and Xu;
Pitas and Kotropoulos “Texture Analysis And Segmentation Of Seismic Images,” International Conference on Acoustics, Speech, and Signal Processing, 1437-1440 (1989); and
B. Russell, D. Hampson, J. Schuelke, and J. Quirein, “Multi-attribute seismic analysis,” The Leading Edge 16, 1439-1444 (1997).

Syntactic pattern classification methods, on the other hand, make decisions based on attributes that are not necessarily numerical and the interrelationships between such attributes. Such an entity-relationship model is an abstract and conceptual account of data that may be represented in the form of an attributed relational graph (“ARG”). Exact or inexact sub-graph matching techniques operating on ARG representation are a powerful syntactic pattern recognition tool. Examples of inexact graph matching methods include:
W. H. Tsai and K. S. Fu, “Error-Correcting Isomorphisms of Attributed Relational Graphs for Pattern Analysis,” IEEE Transactions on Systems, Man, and Cybernetics 9(12) (1979);
A. Sanfeliu and K. S. Fu, “A Distance Measure Between Attributed Relational Graphs for Pattern Recognition,” IEEE Transactions on Systems, Man, and Cybernetics 13(3) (1983);
M. A. Eshera and K. S. Fu, “A Similarity Measure between Attributed Relational Graphs for Image Analysis,” Proc. Seventh International Conference on Pattern Recognition, 75-77 (1984);
M. A. Eshera and K. S. Fu, “An image understanding system using attributed symbolic representation and inexact graph matching,” IEEE Transactions on Pattern Analysis and Machine Intelligence 8(5), 604-617 (1986);
H. Bunke, “Error Correcting Graph Matching: On the Influence of the Underlying Cost Function,” IEEE Transactions on Pattern Analysis and Machine Intelligence 21(9) (1999);
R. M. Cesar, Jr, E. Bengoetxea, I. Bloch, and P. Larrañaga, “Inexact graph matching for model-based recognition: Evaluation and comparison of optimization algorithms,” Pattern Recognition 38(11), 2099-2113 (2005); and
H. Qiu and E. R. Hancock, “Graph matching and clustering using spectral partitions,” Pattern Recognition 39, 22-34 (2006).

In the general category of attributed relational graph matching based fingerprint classification and identification techniques, or moving object tracking in video analysis, the present inventive method is an approach to automatic/semi-automatic seismic interpretation and seismic stratigraphy based on exact or inexact matching of attributed graphs.

### SUMMARY OF THE INVENTION

The present invention can reduce two- or three-dimensional seismic data to a stick figure version that is represented as a graph structure with details captured by attributes associated with the nodes and edges of the graph. The interpreter may pronounce a portion of the graph to be the target pattern that is to be found in the graph. Alternatively, the interpreter may select a pattern from a database, select and modify a pattern from a database, or create an entirely new pattern. The present inventive method then can search the graph for instances similar to the prescribed target.

In one embodiment, the invention is a computer-implemented method for identifying features in 2-D or 3-D volumes of seismic data that relate to potential for hydrocarbon deposits, said method comprising:

reducing the seismic data to a reduced representation;

representing the reduced representation in a graph structure;

associating one or more attributes with elements of the graph structure, thereby creating an attributed relational graph;

selecting a pattern comprising graph elements and associated attributes;

searching the attributed relational graph for one or more occurrences of the selected pattern; and

interpreting said one or more occurrences for indications of hydrocarbon potential; wherein at least the searching is performed using a computer programmed to perform it.

For most practical applications of the present inventive method, the steps of reducing, representing, associating, and searching are all performed using a suitably programmed computer.

### BRIEF DESCRIPTION OF THE DRAWINGS

The present invention and its advantages will be better understood by referring to the following detailed description and the attached drawing in which:

FIG. 1 is a flowchart showing basic steps in one embodiment of the present inventive method;

FIG. 2 shows a seismic section converted to a line representation, i.e. a network of lines called a schematic seismic section;

FIG. 3 shows the graph representation of the schematic seismic section of FIG. 2;

FIG. 4 illustrates an attributed relational graph for the schematic seismic section of FIG. 2;

FIG. 5 illustrates assigning a label attribute to the graph representation of FIG. 3 that at junctions assigns the two longer edges going into a vertex to the same label;

FIG. 6A illustrates an alternative attributed relational graph representation of the schematic seismic section of FIG. 2, and FIG. 6B illustrates various attributes based on polarity patterns;

FIG. 7 shows a seismic cross-section through a 3-D seismic data set;

FIG. 8 shows a line representation of the seismic cross-section of FIG. 7;

FIG. 9 shows the sub-region of FIG. 7 where occurrences of patterns shown in FIG. 11 exist;

FIG. 10 shows a line representation of FIG. 9 with an overlay of segmentation of positive and negative seismic data values, where thick and thin lines represent different types of seismic data regions;

FIG. 11 identifies the specific locations in FIG. 10 where selected patterns (shown at the bottom of FIG. 11) occur;

FIG. 12 shows the sub-region of FIG. 7 where an occurrence of a pattern shown in FIG. 14 exists;

FIG. 13 shows a line representation of FIG. 12 with an overlay of segmentation of positive and negative seismic data values, where thick and thin lines represent different types of seismic data regions; and

FIG. 14 identifies the specific locations in FIG. 13 where a selected pattern (shown at the bottom of FIG. 14) occurs; and

FIG. 15 illustrates that graph structures naturally capture geologic relationships between geologic surfaces.

The invention will be described in connection with example embodiments. However, to the extent that the following detailed description is specific to a particular embodiment or a particular use of the invention, this is intended to be illustrative only, and is not to be construed as limiting the scope of the invention. On the contrary, it is intended to cover all alternatives, modifications and equivalents that may be included within the scope of the invention, as defined by the appended claims. Persons skilled in the technical field will readily recognize that in practical applications of the present inventive method, it must be performed using a computer, typically a suitably programmed digital computer.

### DETAILED DESCRIPTION OF EXAMPLE EMBODIMENTS

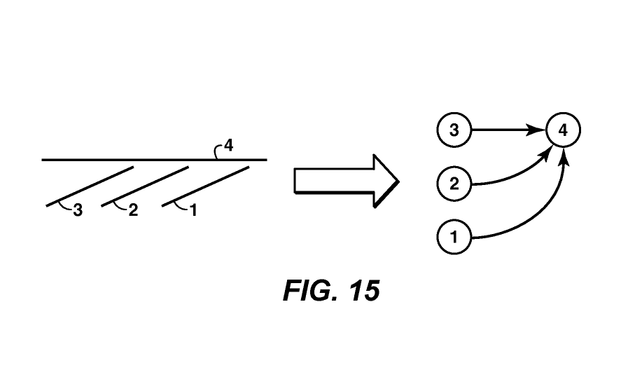

The present inventive method for seismic feature detection converts a two-dimensional seismic dataset to a discrete or reduced representation consisting of curves only or converts a three-dimensional seismic dataset to a reduced representation consisting of surfaces only. The spatial connectivity among the discrete elements of curves or surfaces is key first to the description and then to the capture of geologic features. Spatial connectivity between the discrete elements is naturally expressed using a graph representation that is preferably augmented with attributes that detail properties of the discrete elements and the original seismic data. FIG. 15 demonstrates how effortlessly a graph representation, shown on the right-hand side of the drawing, captures the situation of three surfaces 1, 2, and 3 truncated by an unconformity 4. Thus, an attributed graph is used to embody the discrete representation of the seismic data, which allows locating individual terminations, truncations, and complex geometric arrangements thereof in seismic data. A feature of the present inventive method is in the way that the surfaces, vertices, and edges in the attributed graph are chosen and used, i.e. surfaces, line segments and points of the reduced seismic representation and their relationships are captured and embodied by the attributed graph.

For simplicity, the inventive method is presented for the two-dimensional case, but all concepts, methods, embodiments and applications readily expand to the three-dimensional case.

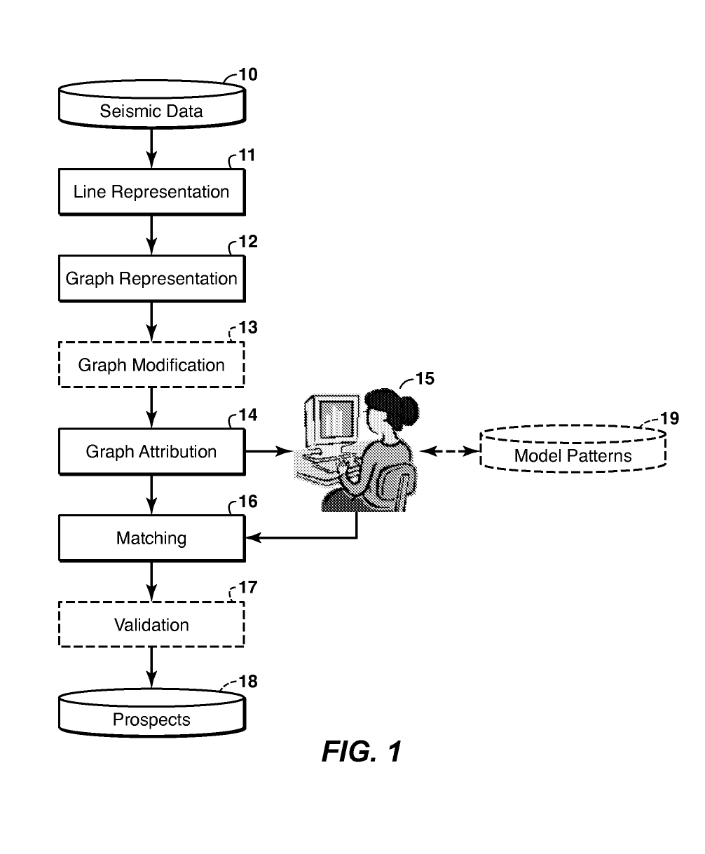

Basic steps of the present inventive method are shown in FIG. 1. At step 11, the seismic data 10 are converted to a line representation. At step 12, the line representation is converted to a reduced graph representation. At step 14, attributes are assigned to graph vertices and edges. At step 15, sub-graphs are selected from the data or an optional database (model pattern). At step 16, the sub-graphs are matched against the graph representation. At step 18, detected sub-graphs are stored for further analysis of the hydrocarbon potential.

Optional steps of the inventive method include step 13, modification of the graph representation; step 17, validation of the detected sub-graphs, and step 19, storage (retrieval) of sub-graphs that represent model patterns in (from) a database.

In mathematics, a graph is an abstract representation of a set of objects where some pairs of the objects are connected by links. The interconnected objects are represented by mathematical abstractions called vertices, nodes or points, and the links that connect some pairs of vertices are called edges, arcs, or links. Typically, a graph is depicted in diagrammatic form as a set of dots for the vertices, joined by lines or curves for the edges. Graphs are one of the objects of study in discrete mathematics.

The edges may be directed (asymmetric) or undirected (symmetric). For example, if the vertices represent people at a party, and there is an edge between two people if they shake hands, then this is an undirected graph, because if person A shook hands with person B, then person B also shook hands with person A. On the other hand, if the vertices represent people at a party, and there is an edge from person A to person B when person A knows of person B, then this graph is directed, because knowing of someone is not necessarily a symmetric relation (that is, one person knowing of another person does not necessarily imply the reverse; for example, many fans may know of a celebrity, but the celebrity is unlikely to know of all his/her fans). This latter type of graph is called a directed graph and the edges are called directed edges or arcs; in contrast, a graph where the edges are not directed is called undirected.

In computer science, a graph is an abstract data structure that is meant to implement the graph concept from mathematics. A graph data structure consists mainly of a finite (and possibly mutable) set of ordered pairs of vertices that are linked by an edge. The vertices may be part of the graph structure, or may be external entities represented by integer indices or references. For the purpose of the inventive method, the details of how a graph is represented and stored in memory are unimportant. A graph data structure may also associate or attribute to each edge or vertex some value, such as a symbolic label and/or numeric attributes (length, polarity, number of edges, average amplitude, etc.).

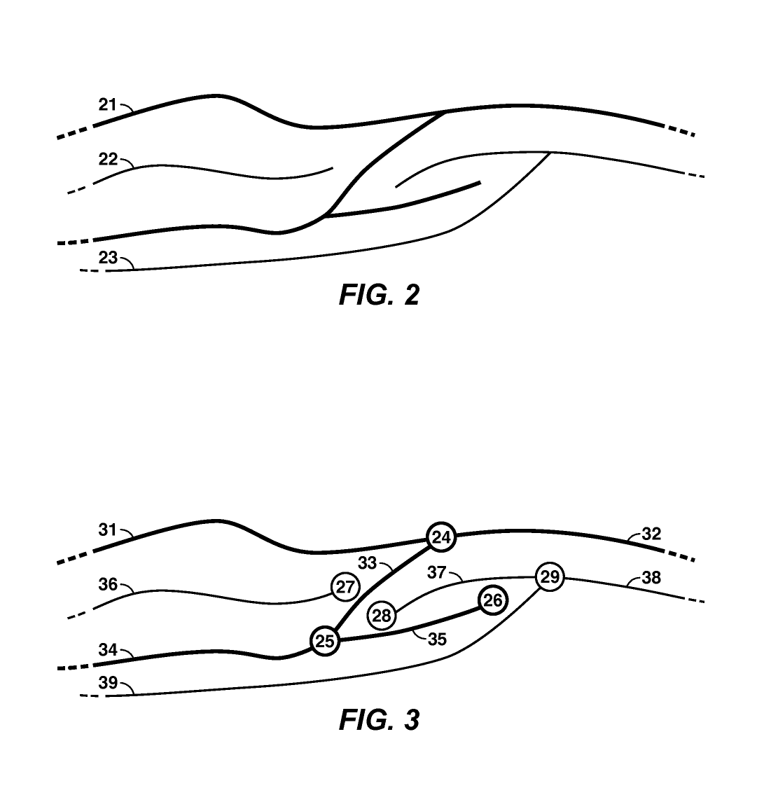

Step 11 of the present inventive method converts seismic image data into a network of lines or segments, i.e., a schematic seismic section. The word image is used because some preferred embodiments of step 1 are based on methods developed for image processing, and a two-dimensional seismic section may be represented as an image. However, other representations of seismic data exist, for example three-dimensional data cubes, wiggle plots, or digital (or analogue) data put in storage on a medium such as a tape. Thus, for the purpose of the present inventive method, the exact representation of the seismic data is irrelevant. FIG. 2, for example, presents a seismic section represented in form of a sketch that consists of one simple event 22 and two compound events 21 and 23. The difference in stroke thickness indicates event polarity, i.e., peak (positive event) or trough (negative event). The dashes indicate that the events are parts of larger ones, but truncated for illustrative purposes. One method is based on morphological thinning methods used in image processing. Seismic data are first blocked to binary images, for example by reducing the data to just their polarities, e.g., ±1. Bands of value +1 are reduced to lines with a value of +1 with equivalent connectivity, for example by application of morphological thinning Bands of value −1 are reduced to equivalent lines with a value of −1. All other samples are set to zero. Another method is based on medial axis transforms of blocked seismic data. A similar result is obtained from the apparent polarity attribute that is formed by the polarity of instantaneous phase computed at the local amplitude extrema. Both morphological thinning and medial axis transformation will reduce reflection events to lines. Without further attention, however, the apparent polarity attribute may reduce single reflection events to disconnected points or line segments. Often, some post-processing is required to link up disjointed points and segments. As a result, a seismic image can be represented by a network of lines as shown in FIG. 2.

Step 12 consists of the conversion of the schematic seismic section or its line representation to a graph. FIG. 3 depicts a graph representing the schematic section of FIG. 2. Event 21 in FIG. 2 is assigned to edges 31 to 35 in FIG. 3 that connect vertices 24-26. A vertex of the graph is thus a location where a seismic event splits or merges (a junction or bifurcation) in terms of FIG. 2. FIG. 3 also shows terminal vertices 26-28, where an event terminates. Because edges connect two vertices, events that terminate without merging in or splitting from another event can not be represented without the introduction of terminal vertices that indicate the end of an event. FIG. 3 still somewhat resembles the original seismic sketch of FIG. 2, for example shape, polarity, orientation or length. On the other hand, there are other ways of converting a schematic seismic section to a graph. For example, a line segment between two bifurcation points or terminal points in FIG. 2 can be represent by a vertex in a graph, while the contacts of a line segment with other line segments can be represented by edges in a graph.

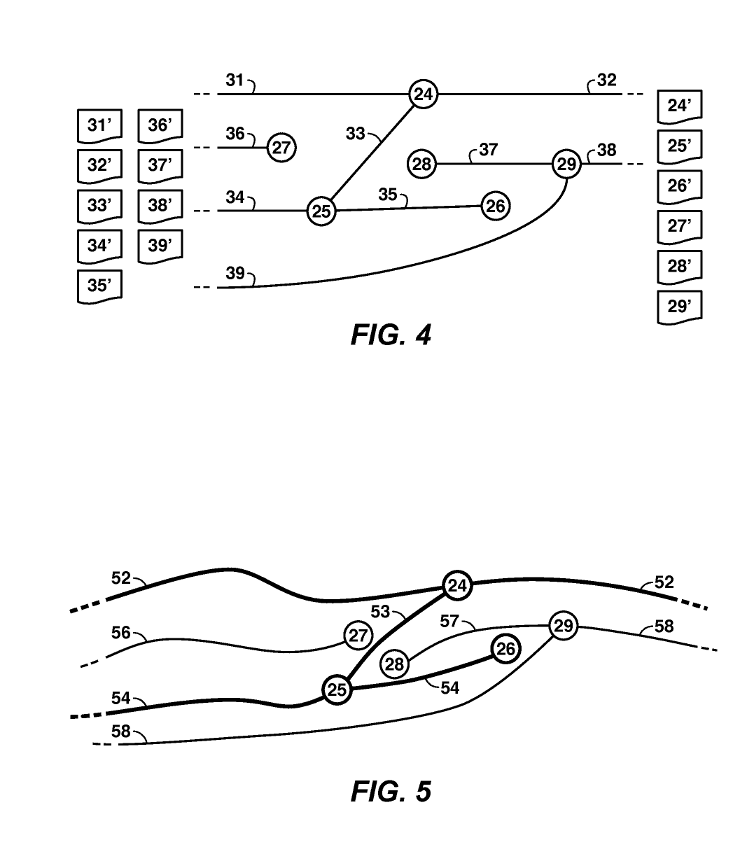

In step 14 of FIG. 1, the graph is attributed. Various attributes can be assigned to vertices and edges of a graph to further explain the relationships betweens lines in FIG. 3. FIG. 4 presents an attributed graph of the seismic sketch of FIG. 2. Details of the graph with regard to the vertices are captured by the vertex attributes 24′ to 29′, while details with regard to edges are captured in edge attributes 31′ to 39′. For the present inventive method, the vertices may be attributed, the edges may be attributed, or both may be attributed. Thus, in the present inventive method, attributes need not be distinguished into vertex and edge attributes. The graph itself suffices to capture connectivity between vertices, i.e., how junctions are connected. Attributes includes polarity, location, or length.

The optional step 13 modifies the graph and/or the attributes. To give an example of the present inventive method, FIG. 1 shows that modification is performed before attribution. Modification and attribution, however, may be performed in either order or be combined. Moreover, modification and attribution may be repeated multiple times. For example, the graph may be attributed, modified based on attributes, and then be further attributed.

Modifications include pruning of short edges that connect to a terminal vertex. Take for example edge 37 in FIG. 3 that connects vertex 29 to terminal vertex 28. Since it is short, both edge 37 and vertex 28 may be removed. But without edge 37, vertex 29 becomes superfluous and can be removed if edges 38 and 39 are combined. The newly combined edge 38 & 39 needs to be attributed again, or at least have its attribute sets combined. Similarly, edge 35 and vertices 25 and 26 might be removed and edges 33 and 34 be combined.

Another attribution is assignment of labels. Multiple edges, for example, can be assigned the same label to form a larger object. FIG. 5 demonstrates this attribution for the example of FIG. 3. At vertex 24 of FIG. 3, either edge 31 or 33 can be assigned to the same label as edge 32. Because edge 31 is longer than 33, 31 is assigned with the label of 32. Thus 31 and 32 of FIG. 3 are both assigned the label 52 in FIG. 5. Similarly, edge 39 of FIG. 3 is assigned with the label of 38 because 39 is larger than 37. Both 38 and 39 of FIG. 3 are assigned the label 58 in FIG. 5.

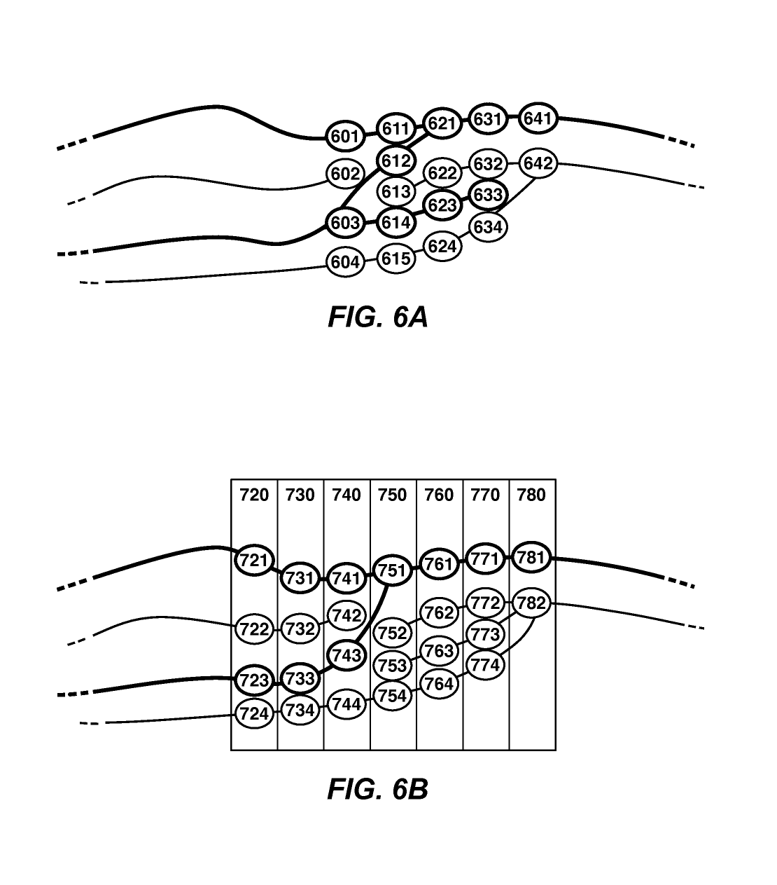

An alternative embodiment of steps 11 to 14 introduces a third kind of vertex, pass-through nodes. Seismic data samples are often located on a two- or three-dimensional Cartesian grid. Seismic data are organized in traces that are located at discrete locations. Vertices are placed at the intersections of events with traces. FIG. 6 presents some vertices from the example of FIG. 2. Vertices 602, 613, and 633 are terminal vertices. Vertices 603, 621 and 642 are bifurcation vertices. All others, e.g., 601, 604, 611 or 614, are pass-through vertices. In the present inventive method, the vertices may be attributed. In this particular embodiment, the role of edges is limited, however, to tie vertices between neighboring traces. Moreover, edges can even be made implicit by defining vertex attributes that capture the connectivity between vertices of neighboring traces.

Attributes defined for the graph embodiment of FIG. 6A include vertex label, event label, vertex location in x, y, and z (or t), or vertex location on the Cartesian grid of seismic samples; labels of vertices connecting to the left (right), label of the leftward (rightward) vertex with the same event label, polarity of the event, vertex type (pass-through, terminal, or bifurcation), number of vertices connected from the left (right), number of leftward (rightward) vertices for the given event, number of leftward (rightward) vertices to the next bifurcation vertex, or a flag for bifurcation vertices indicating bifurcation to the left (right). It is obvious that other attributes can be defined, and all are within the scope of the present invention.

All attributes specified so far relate to directly connected vertices. Attributes of vertex 633 relate to properties at 633 such as polarity, amplitude, or location; or how 633 connects to 623, 614, or 603. But vertex 633 is not connected with either 632 or 634, and thus, so far no attributes specify properties between 633 and 632 or 634. Such vertical relationships can be established by searching the graph for vertices that satisfy a specified condition of the location attribute. Alternatively, a secondary graph structure may be overlain over the attributed graph to implicitly or explicitly define geometrical relationships between vertices or edges, such as declaring vertices 601, 602, 603, and 604 to belong the same trace.

Additional attributes for a specific vertex can be formed by examination of graphs related to vertices above and/or below that vertex. One example is the number of rightward vertices such that the vertices of the upper, center, and lower graphs satisfy a specified relationship. This relationship between different neighboring branches of the graph may be based, for example, on the vertex polarities. Referring to FIG. 6B, vertex 722, for example, is sandwiched between vertices 721 and 723 that both have a polarity different than 722. The same pattern is exhibited by 732, 731, and 733; and 742, 741 and 743. For vertex 722, there are thus three rightward vertices that differ in polarity both to their respective upper and lower vertices before reaching bifurcation vertex 751.

Another example is the number of rightward vertices that are sandwiched between vertices that on one side exhibit the same polarity while the other side exhibits the opposing polarity. An example is 752 that is above 753 exhibiting the same polarity but below 751 with opposing polarity. This pattern is repeated with 762, 761, and 764; and 772, 771, and 773. For vertex 752, the number of rightward vertices where the polarity above differs from the polarity below before reaching a bifurcation is three. A last example, without limitation, is the number of rightward vertices that are sandwiched between vertices with the same polarity before reaching a bifurcation vertex. Vertex 753 is sandwiched between 752 and 754, all exhibiting the same polarity. The pattern is repeated for 763, 762 and 764; and 773, 772 and 774 before reaching bifurcation 782, and thus, the number of rightward repetitions of this polarity pattern is also three. In all these examples, the counts were performed in the rightward direction, and so the attribute of rightward vertices that have the same polarity as their upper and lower vertices differs between 753, 763, and 773. Similar attributes may be defined in the leftward direction. Another example is the number of leftward (rightward) vertices before reaching a bifurcation vertex that are above (below) a bifurcation vertex. In alternative embodiments, all vertices of one branch of the graph are assigned the same attribute value, for example the maximum number of rightward vertices exhibiting a specified polarity pattern.

Lastly, some attributes may be taken from the original seismic data or their derivative products that are often called seismic attributes. Any seismic attribute, preferably related in a spatial manner to the location of the edge or vertex in the original data, can be used to further attribute the graph, i.e., the edge or vertex.

A graph and associated attributes such as shown in FIG. 4 may be said to form an attributed relational graph (“ARG”).

The following paragraphs illustrate preferred embodiments of Steps 12 and 14. The purpose of the attributed relational graph (ARG) is forming a graph representation that characterizes the neighborhood relationships between reflectors in the schematic seismic section as well as capturing details about the seismic data in the form of attributes associated with graph elements. A two-dimensional seismic cross section can be seen as equivalent to an image with Nᵣ×N_{c} pixels, where Nᵣ and N_{c} are the number of rows and columns of this image. Elements 720, 730 . . . 780 represent such columns (see FIG. 6B). The ARG representation of the schematic seismic section is organized as an array of column attributes CA={CA(k)}ₖ₌₁^{N}^{_{c}}, where each column attribute element CA(k) is an array of attribute structures representing the column k. Thus, column 720 is associated with CA(720) which is an array of attribute structures that store select attributes of vertices 721, . . . , 724. Each structure in CA(k) represents the relational attributes of a single vertex as well as between connected vertices. The index k establishes the secondary graph structure which arranges vertices within a trace or column in a top-down manner. If the current column is the k-th column on the image, then the attributes associated with that column are expressed in CA(k), and the attributes associated with the left column and the right column are expressed as CA(k−1) and CA(k+1), respectively.

A preferred core set of attributes may describe the vertices and their interrelationships for the later steps of the inventive method, i.e., searching for a variety of patterns. Table 1 summarizes a preferred attribute set where the index k represents the column or trace number, while the index p represents the index of the vertex within one column in a top-down manner.

TABLE 1
A core set of attributes.

| Attribute | Variable | Values |
|---|---|---|
| Label | CA(k).label(p) | Integer label |
| Position | CA(k).pos(p) | (row, col) |
| Polarity | CA(k).sign(p) | Maximum or peak (+1), |
| | | Minimum or trough (−1) |
| Left Side Line | CA(k).leftLineLength(p) | Number of left-connected |
| Length | | vertices |
| Right Side Line | CA(k).rightLineLength(p) | Number of right-connected |
| Length | | vertices |
| Left Side Segment | CA(k).leftSegLength(p) | Number of left-connected |
| Length | | vertices to next bifurcation |
| Right Side | CA(k).rightSegLength(p) | Number of right-connected |
| Segment Length | | vertices to next bifurcation |
| Trough Terminal | CA(k).end_min(p) | Yes (1), No (0) |
| Vertex | | |
| Peak Terminal | CA(k).end_max(p) | Yes (1), No (0) |
| Vertex | | |
| Trough | CA(k).bifurcation_min(p) | Yes (1), No (0) |
| Bifurcation | | |
| Peak Bifurcation | CA(k).bifurcation_max(p) | Yes (1), No (0) |
| Left Neighbor | CA(k).leftNeighbor(p) | Index of the left side |
| | | neighbor on the same line |
| Right Neighbor | CA(k).rightNeighbor(p) | Index of the right side |
| | | neighbor on the same line |
| Sandwich Left Seg | CA(k).sandwichLeftLength(p) = (a, b, c) | Number of left-side vertices |
| Length | | to the next bifurcation. |
| | | Parameters a, b, c are |
| | | defined below. |
| Sandwich Right | CA(k).sandwichRightLength(p) = (a, b, c) | Number of right-side |
| Seg Length | | vertices to the next |
| | | bifurcation. Parameters a, |
| | | b, c are defined below. |
| Lateral Branch | CA(k).branchDir(p) | Left branch (−1), no branch |
| Direction | | (0), right branch (1) |
| Vertical Branch | CA(k).branchVertDir(p) | Upward branch (−1), no |
| Direction | | branch (0), downward (1) |
| Notes: | | |

| | |
|---|---|
| Parameter | Definition |
| a | The number of vertices on the reduced line representation that are |
| | sandwiched by two lines of polarity different from that of said line. |
| b | The number of vertices on the reduced line representation that is |
| | adjacent to one line of polarity different from that of said line. |
| c | The number of vertices on the reduced line representation that is |
| | sandwiched by two lines of the same polarity as that of said line. |
| a + b + c | The total number of vertices of said reduced line. |

Returning to the flowchart presented in FIG. 1, the user defines a pattern of interest, shown as step 15. The term user denotes an individual or a group of people that interact with the inventive method. The user or user group may change throughout the application of the inventive method. In some embodiments of the inventive method, the user may even be an algorithm or computer program that uses the inventive method in a stand-alone manner or within a larger seismic pattern recognition system.

The user may examine the graph and select a portion of the graph (a sub-graph) to serve as a model pattern (also model or pattern) to be detected in the input graph. A sub-graph may be created by deleting selected vertices from a graph. Alternatively, the user can create a pattern in form of a typically small graph on the computer in an interactive manner. The user may also combine patterns (or small graphs) in a combinatorial manner that forms at least some of the possible combinations of the given graphs. The user may also retrieve graphs or sub-graphs representing model patterns stored in an optional database. As a final example, the user may modify or edit the pattern or graph. A practitioner of the art will recognize that steps 14 and 15 may be performed sequentially, essentially sequentially, in parallel; in one location or at multiple locations; in hardware, software and vaporware; and that steps may be omitted, repeated, or reordered. These variations are just examples, and all variations are within the scope of the present inventive method.

Continuing with the flowchart of FIG. 1, step 16 searches the input graph generated in step 13 or 14 for instances of the pattern or sub-graph specified in step 15. Exactly matching the pattern with the graph is possible. Preferably, however, inexact graph matching is performed that allows for small variations between the specified and detected patterns. Exact graph matching can be viewed as the problem of finding a mapping between the vertices of the pattern or sub-graph and the vertices of a second, often larger, graph such that vertices connected by an edge in the sub-graph are mapped to vertices connected by an edge in the larger graph. In other words, the sub-graph and the matched portion of the larger graph are isomorphous. Often, no such map can be found without adding or suppressing some vertices or edges or changing their attributes. In other words, some degree of error tolerance may need to be incorporated in the graph matching process and the graph matching is called inexact. With enough modifications, however, any sub-graph or pattern can be adapted to match any given portion of another graph! To avoid this extreme, a measure may be associated with the match that expresses the similarity between the specified pattern and a portion of the larger graph. One first method of inexact graph matching is based on the maximum common sub-graph between the pattern graph and portion of another, larger graph. The maximum common sub-graph is the largest sub-graph that is common to two graphs. The larger the maximum common sub-graph, the more similar the two compared graphs are.

Another graph similarity measure employs a cost function or graph edit distance that counts how many deletions, insertions, or substitutions are needed to achieve an isomorphism between sub-graph and graph at a given vertex. The fewer operations are needed, the more similar the graphs are. In practice, some edit operations may be more important than others and different costs may be associated with different operations. The more likely an edit operation is to occur, the smaller is its associated cost. Some classical methods for inexact or error-tolerant graph matching rely on a tree search to find the minimum number of operations required to achieve graph isomorphism. While these methods are guaranteed to find an optimal sequence of operations and thus the minimum cost, they require exponential time and memory due to the complexity of the problem because many of these methods test every possible combination of keeping and dropping vertices. Heuristic look-ahead methods may be used to prune the search space, but computer run-time may remain prohibitive. Suboptimal or approximate methods are bounded in the number of computational steps, but may fail to find the minimum cost. Examples include probabilistic relaxation schemes, neural networks, genetic algorithms, or maximum flow methods. All of these methods may get trapped in local minima and miss the optimal solution.

Other inexact graph matching methods are based on linear programming or eigenvalue decompositions that may allow breaking the graphs to be matched into smaller sub-graphs for matching in a hierarchical framework using parallel processes.

In the inventive method, further efficiencies can be achieved by taking advantage of the attributes associated with edges and vertices that allow prioritization of different portions of the graph and increase of discriminative power of the cost function.

Continuing with the flowchart of FIG. 1, optional step 17 validates the found matches. In a preferred embodiment of the inventive system, the user visualizes the found matches to determine whether the results meet expectations. Based on the results, the user may enlarge or reduce the sub-graph for the pattern to be found. If too many targets are detected, then the user may render the target definition more stringent by enlarging the sub-graph. If fewer than expected targets are found, then the user may render the target definition less stringent, for example by reducing the sub-graph. Alternatively, the user may select or construct an entirely different pattern sub-graph. As a last example, the user may adapt the current cost function or choose an entirely different cost function.

Some embodiments of the present inventive method use a cost function to determine graph matches. Every found match is associated with a cost that allows ranking the matches, for example, from best to worst. The user may validate the found matches by inspecting which matches are ranked highly. If unexpected targets are ranked highly or desired targets are ranked low, the user adapts the sub-graph or the cost function.

Step 18 of FIG. 1 is storage of the found matches in a database, in computer memory or on another storage medium for further analysis or other real-world application. Finally, the optional step 19 in FIG. 1 provides for storage of sub-graphs or model patterns in an optional database for reuse.

A preferred application for the present inventive method is based on two-dimensional slices extracted from a three-dimensional dataset. The user selects a slice orientation that preferentially showcases the feature of current interest, for example an orientation aligned with the dip or strike of some feature of particular interest. Alternatively, the user may choose a slice arbitrarily traversing through the data. The user then selects or constructs a sub-graph for the target pattern and uses the inventive method to locate instances of the target not only in the chosen slice but also in neighboring slices, which allows spatial cross-validation. The goal of this validation process is twofold. First, it validates if the same geologically significant pattern is detected in similar locations in neighboring slices. Due to the measurement and processing noise, there may be differences or errors in the graph and associated attributes, which lead to errors in the detection. Second, it also provides a measure of consistency and validity of the detection. Having more neighboring slices featuring the same pattern at similar locations indicates a higher likelihood of a meaningful detection. Moreover, such a measure can be weighted further by taking the cost function or graph edit distance into account, i.e., by assigning patterns that better resemble the target a higher weight.

### EXAMPLE

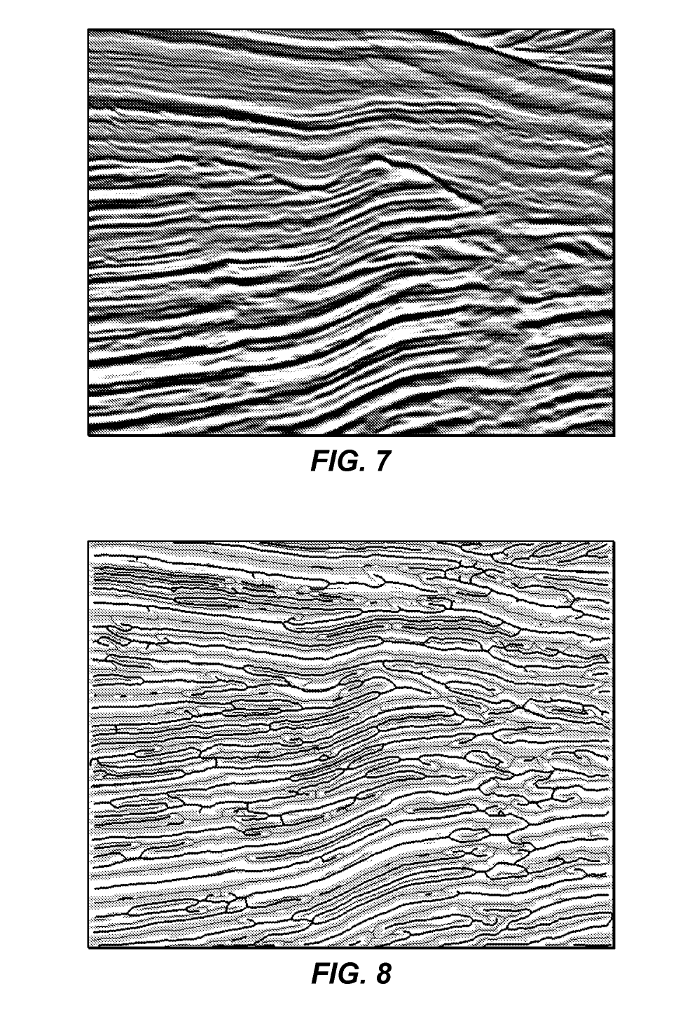

FIG. 7 presents an example seismic slice extracted from a three-dimensional seismic dataset. The seismic data values are reduced to just their polarities, for example by application of the sign function, and then further concentrated by morphological thinning to lines as shown in FIG. 8. The white regions of FIG. 8 represent the seismic data value area of positive polarity in FIG. 7, while the gray regions of FIG. 8 represent the seismic data value area of negative polarity in FIG. 7. Thinning and morphological operations further reduce these regions to line representations also shown in FIG. 8, where thin lines represent the gray regions and the thick lines represent the white regions. This condensed version of the data slice is then converted to an attributed graph (not shown). The attributes that will be used in this example are polarity, length of a reduced segment, location of a vertex (end or bifurcation), direction (upward or downward) of branching, and presence (above or below) of segments of opposite polarity.

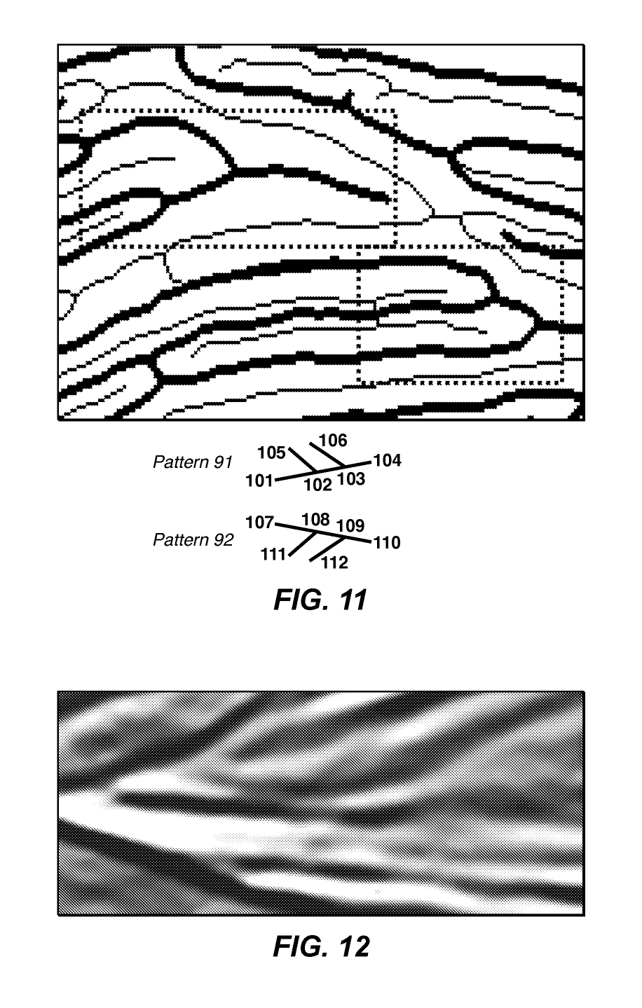

Consider four geologically or geophysically interesting patterns 91, 92, 93, and 94 defined in FIGS. 11 and 14, as provided by a user at step 15 in the flowchart of FIG. 1.

Pattern 91, as illustrated by the stick diagram at the bottom of FIG. 11, is described below:
There is a right ending vertex 104, and the segment containing 104 is at least partially sandwiched by two lines of different polarity from that of 104 for 20 pixels or more.
There is a bifurcation point 103 to the left of 104, and 103 is of the same polarity as 104. The segment length between 104 and 103 is 10 pixels or more. The branching of the segment between 103 and 106 is upwards.
   There is a bifurcation point 102 to the left of 103, and 102 is of the same polarity as 103. The segment length between 102 and 103 is between 10 and 60. The branching of the segment between 102 and 105 is upwards.

Pattern 92, as illustrated by the stick diagram at the bottom of FIG. 11, is described below:
There is a right ending vertex 110, and the segment containing 110 is at least partially sandwiched by two lines of different polarity from that of 110 for 20 pixels or more.
There is a bifurcation point 109 to the left of 110, and 109 is of the same polarity as 110. The segment length between 110 and 109 is 10 pixels or more. The branching of the segment between 109 and 112 is downwards.
There is a bifurcation point 108 to the left of 109, and 108 is of the same polarity as 109. The segment length between 108 and 109 is between 10 and 60. The branching of the segment between 108 and 111 is downwards.

Pattern 93, as illustrated by the stick diagram at the bottom of FIG. 14, is described below:
There is a left ending vertex 113, and the segment containing 113 is at least partially sandwiched by two lines of different polarity from that of 113 for 20 pixels or more.
There is a bifurcation point 114 to the right of 113, and 114 is of the same polarity as that of 113. The segment length between 113 and 114 is 10 pixels or more. The branching of the segment between 114 and 117 is upwards.
There is a bifurcation point 115 to the right of 114, and 115 is of the same polarity as that of 114. The segment length between 114 and 115 is between 10 and 60. The branching of the segment between 115 and 118 is upwards.

Pattern 94, as illustrated by the stick diagram at the bottom of FIG. 14, is described below:
There is a left ending vertex 119, and the segment containing 119 is at least partially sandwiched by two lines of different polarity from that of 119 for 20 pixels or more.
There is a bifurcation point 120 to the right of 119, and 120 is of the same polarity as 119. The segment length between 119 and 120 is 10 pixels or more. The branching of the segment between 120 and 123 is downwards.
There is a bifurcation point 121 to the right of 120, and 121 is of the same polarity as 120. The segment length between 120 and 121 is between 10 and 60. The branching of the segment between 121 and 124 is downwards.

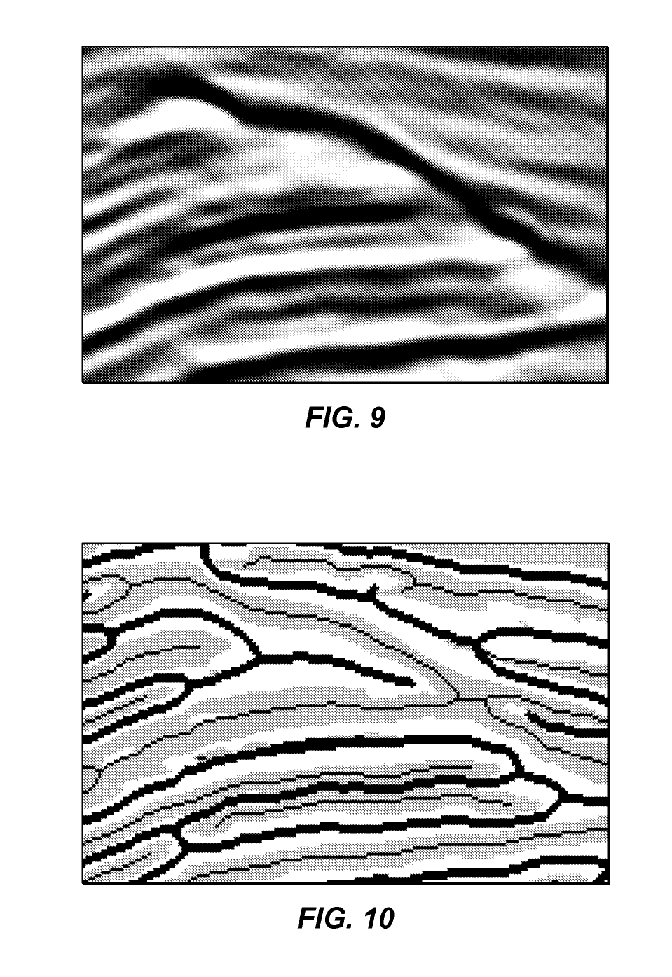

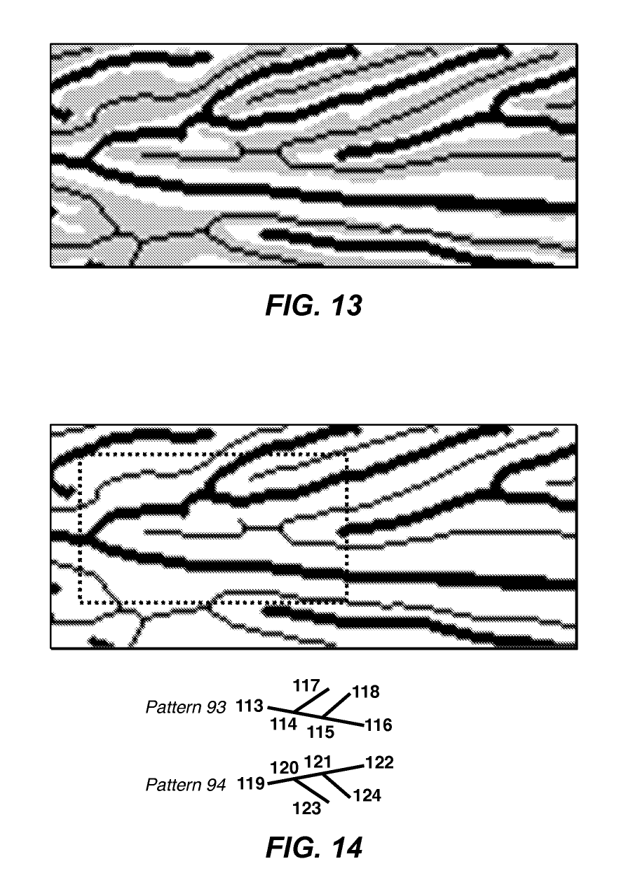

With these four pattern specifications, four ARG model patterns can be constructed. FIG. 9 shows the seismic data from the sub-region in FIG. 7 where both patterns 91 and 92 occur. FIG. 10 shows the reduced line representation for FIG. 9 overlaid on the segmentation map of regions with different polarities in FIG. 9. Finally, FIG. 11 shows the locations indicated by the dotted line boxes where patterns 91 and 92 occur within the region of FIG. 9. Similarly, FIGS. 12-14 show the sub-region of FIG. 7 where the pattern 94 is detected. Although pattern 93 looks similar to pattern 94, pattern 93 exists neither in this sub-region (FIG. 13) nor anywhere in the entire section (FIG. 8). Note that these three locations indicated by the dotted boxes in FIGS. 11 and 13 are the only locations in the entire section (FIG. 8) where the patterns 91, 92, and 94 are found exactly.

The foregoing application is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined in the appended claims.

1. A computer-implemented method for identifying features in 2-D or 3-D volumes of seismic data that relate to potential for hydrocarbon deposits, said method comprising:
reducing the seismic data to a reduced representation;
representing the reduced representation in a graph structure, and analyzing the graph structure for spatial connectivity between elements of the graph structure;
associating one or more attributes with elements of the graph structure, thereby creating an attributed relational graph;
selecting a pattern comprising graph elements, their spatial connectivity, and associated attributes;
searching the attributed relational graph for one or more occurrences of the selected pattern; and
interpreting said one or more occurrences for indications of hydrocarbon potential;
wherein at least the searching is performed using a computer programmed to perform it.

2. The method of claim 1, wherein the seismic data are a 2-D volume, the reduced representation is a line representation, the graph structure includes edges and vertices, the one or more attributes are associated with the edges or vertices, and the selected pattern comprises edges, vertices, and associated attributes.

3. The method of claim 2, wherein the line representation is achieved by reducing reflection events from the seismic data to lines using morphological thinning or medial axis transformation.

4. The method of claim 2, wherein the vertices in the graph structure indicate where seismic events merge, split, or end, and the edges in the graph structure are based on lines in the line representation, and connect or pass through the vertices.

5. The method of claim 2, wherein the edges represent seismic events, and one of the attributes is polarity of the seismic events that the edges represent.

6. The method of claim 1, wherein the seismic data are a 3-D volume, the reduced representation is a surface representation, the graph structure includes edges and vertices capturing how surfaces intersect, merge, or separate; the one or more attributes are associated with the edges or vertices, and the selected pattern comprises edges, vertices, and associated attributes.

7. The method of claim 1, wherein the pattern is based on a selected portion of the graph structure or is selected from a table of patterns having hydrocarbon significance.

8. The method of claim 1, further comprising modifying the graph structure or the one or more attributes to simplify and bring out fundamental features.

9. The method of claim 1, wherein the searching uses inexact matching to find occurrences of the selected pattern in the graph structure.

10. The method of claim 9, wherein the inexact matching is based on a selected graph similarity measure that quantifies a match.

11. The method of claim 1; wherein a 3-D volume of seismic data is divided into 2-D cross sections that are processed by the method separately until being combined for the interpreting.

12. The method of claim 1, wherein at least the selecting and the interpreting are performed by a human user of the method.
